(19) United States
(12) Patent Application Publication
(10) Pub. No.: US 2003/0126180 A1
(43) Pub. Date: Jul. 3, 2003

(54) Arrangement for relating contacts to a context

(76) Inventors: Frank J. Bogart, Boulder, CO (US); Camille Gabriel, Baulkham Hills (AU); Sarah Hildebrandt Kiefhaber, Boulder, CO (US); Rebecca Kay Phelps, Westminster, CO (US)

Correspondence Address: Docket Administrator (Room 1L-202), Avaya Inc., 101 Crawfords Corner Road, P.O. Box 629, Holmdel, NJ, 07733-3030, US

(21) Appl. No.: 10/037,275

(22) Filed: Jan. 3, 2002

(51) Int. Cl. G06F 7/00

(52) U.S. Cl. 709/100

(57) ABSTRACT

Each instance of communication (a contact) between a contact center and a customer of the contact center has its own contact record. Contact records of a customer that deal with the same matter are linked to a communication record that corresponds to that customer and matter.

### TECHNICAL FIELD

This invention relates to customer contact management and customer relationship management arrangements.

### BACKGROUND OF THE INVENTION

Call centers, also referred to as contact centers when they handle communications media other than phone calls, for distributing customer communications for servicing among a plurality of resources, e.g., agents, are well-known in the art. Also known are customer relationship management arrangements that conglomerate and abstract information about all of the contacts between a customer and a contact center in order to provide better and more efficient service to the customer and to provide a better understanding of the customer's needs and value to a business which is represented by the contact center.

Based upon call tags indicative of the identity of the customer, e.g., the calling telephone number, an e-mail address, or an account number, the customer relationship management arrangement is able to identify and link various individual contacts of an individual customer. However, a customer may contact a contact center regarding numerous matters; likewise, numerous entities, e.g., individuals, may contact the contact center regarding a matter on behalf of a single customer. It would be advantageous to separate the customer's contacts by subject matter and to link different individuals' contacts regarding an individual customer's single subject matter. It may also be advantageous to associate some information with a customer's matter as a whole, without associating that information with any individual contact concerning that matter. Unfortunately, known contact centers and customer relationship management arrangements generally lack such capability.

### SUMMARY OF THE INVENTION

This invention is directed to meeting these and other needs of the art according to the invention. Generally according to the invention, each instance of communication (a contact) between a contact center and a customer of the contact center (e.g., a calling or a called party) has its own contact record containing information about the contact. Contact records of a customer that deal with the same matter are linked to a communication record that corresponds to that customer and matter and contains information about that matter. The communication record thus provides a context for the contacts.

One aspect of the invention comprises the following steps: Responding to each instance of communication between a contact center and a customer of the contact center regarding at least one matter by creating for that instance in a storage medium a contact record that includes information about that at least one matter. Responding to each said instance by determining whether an individual said matter is a matter of an existing communication of the customer comprising at least one prior communication instance between the customer and the contact center. Responding to a determination that the individual matter of the instance is not a matter of any said existing communication by creating for that communication of the customer in the storage medium a communication record corresponding to the individual matter and including information about that individual matter, and linking the contact record with the communication record. And responding to a determination that the individual matter of the instance is a matter of an existing communication of the customer by linking the contact record with the communication record.

Another aspect of the invention comprises the following: A storage medium for storing contact records and communication records. A plurality of the contact records, each representing a different instance of communication between a contact center and a customer of the contact center regarding at least one matter and including information about that at least one matter. A plurality of the communication records, each corresponding to a different one of a plurality of matters of the customer, including the at least one matter, each communication record being linked to each contact record of the plurality of contact records that corresponds to the same matter as the communication record and including information about the matter. And an arrangement connected to the data storage and responsive to instances of communication between the customer and the call center, for generating and linking corresponding contact records and communication records.

Where the invention has been characterized in terms of a method, it also encompasses apparatus that performs the method. The apparatus preferably includes an effector-any entity that effects the corresponding step, unlike a means-for each step. The invention further encompasses any computer-readable medium containing instructions which, when executed in a computer, causes the computer to perform the method steps.

The invention enables multiple contacts of a customer regarding a common matter to be linked together and treated as one entity, referred to herein as a communication. Those contacts may occur over several distinct types of communication media, such as e-mail, web request, fax, telephone call, voice-mail, etc. A single contact that relates to several matters may be linked to several communications. A communication also serves as an entity for associating information about the matter with the matter in general, without having to associate the information with an individual, or each, contact that pertains to the matter.

These and other features and advantages of the invention will become more apparent from the following description of an illustrative embodiment of the invention considered together with the drawing.

### BRIEF DESCRIPTION OF THE DRAWING

FIG. 1 is a block diagram of a customer contact center that includes an illustrative embodiment of the invention;

FIG. 2 is a schematic diagram of relationships between contact records and communication records of a database of a customer relationship management system of the customer contact center of FIG. 1;

FIG. 3 is a block diagram of the data structures that implement the records and relationships of FIG. 2; and

FIGS. 4 and 5 are a functional flow diagram of creation and use of the data structures of FIG. 3.

### DETAILED DESCRIPTION

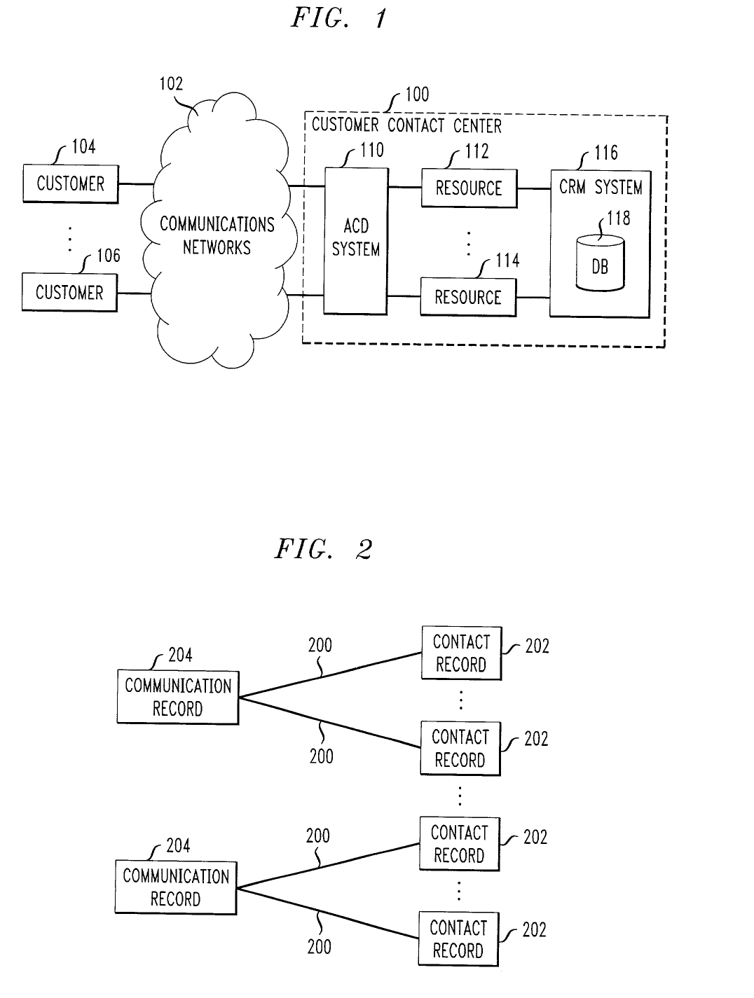

FIG. 1 shows a substantially conventional customer contact center 100. Contact center 100 is connected to one or more communications networks 102, such as the telephony network and/or the Internet, through which it receives and/or makes contacts with customers 104-106. A contact is an individual instance of a communication, such as a telephone call, a fax, an e-mail, a web request, a voice-mail, etc. Contacts are distributed for servicing (handling) in contact center 100 among a plurality of resources 112-114 by a conventional automatic call distribution (ACD) system 110. Resources 112-114 may include electronic resources, e.g., interactive voice response systems, but typically comprise human resources, i.e., agents equipped with telephones and workstations. Resources 112-114 are in data communication with a customer relationship management (CRM) system 116. CRM system 116 is an intelligent system comprising an appropriately-programmed computer, and a relational database (DB) 118 for storing contact-related information.

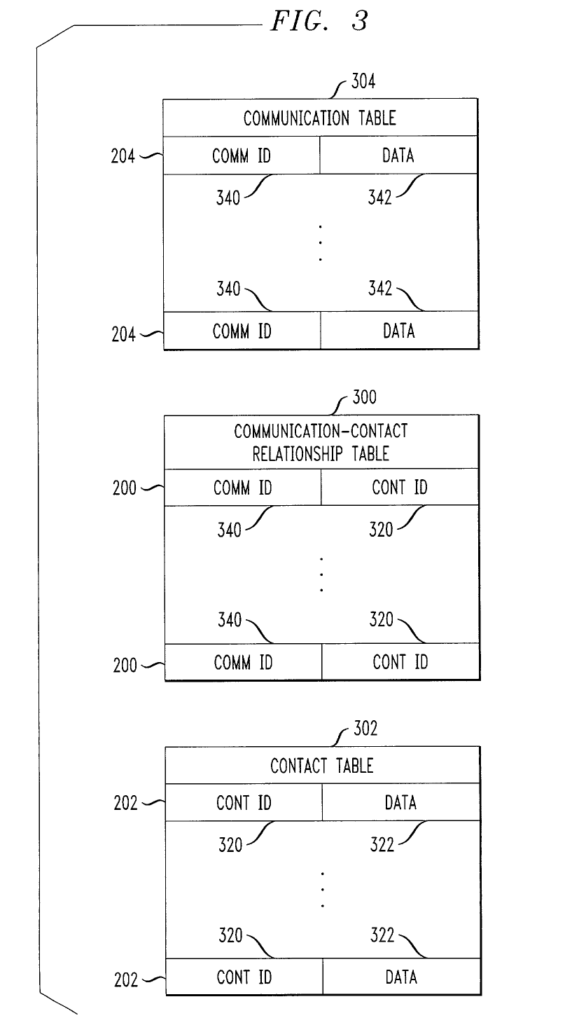

According to the invention and as shown in FIG. 2, DB 118 not only stores contact records 202 containing information about individual contacts, but also stores communication records 204 containing information about individual matters of a customer. A matter is a subject or object of communication, e.g., product repair, a loan application, an account balance, a change of address, etc. A communications record usually pertains to a single matter, and its record is linked 200 together with all contact records 202 of all contacts that relate to that matter. A communication thus provides a context for one or more contacts and links those contacts within that context.

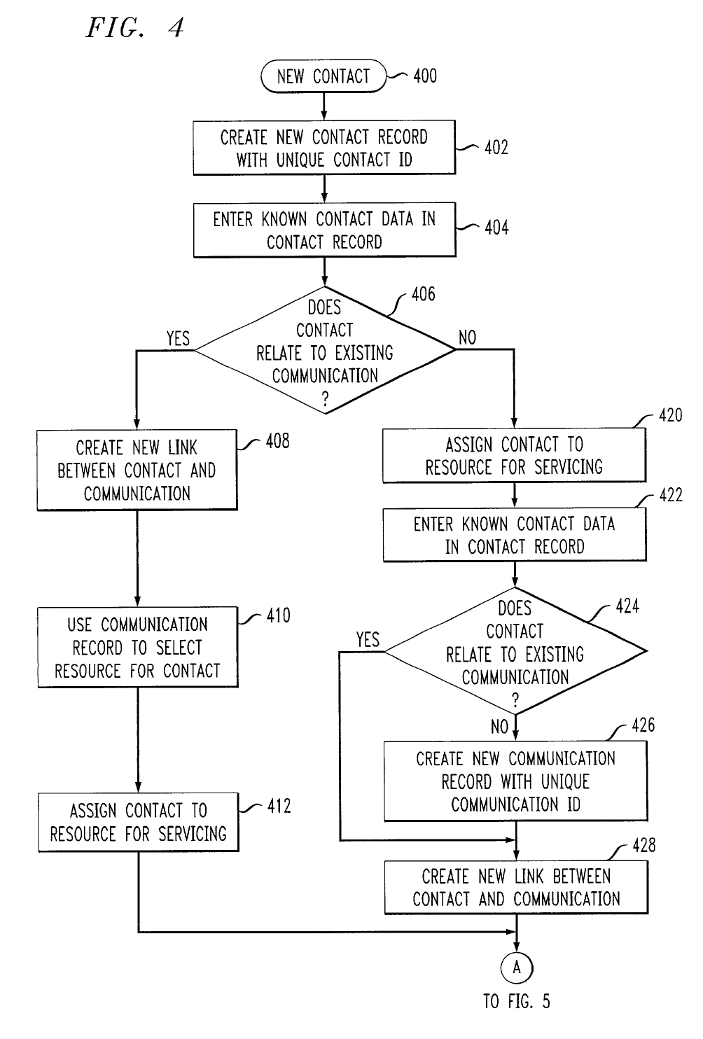

As shown in FIG. 3, records 202 and 204 and links 200 are illustratively implemented as table entries in DB 118. A contact table 302 has entries each one of which comprises a contact record 202. Each contact record 202 has a contact ID 302 that uniquely identifies the contact, and a plurality of data fields 322 that contain any desired information about the contact, e.g., medium of communication, source or destination or customer identifier, start and stop times, identifier of the resource or resources that handled the contact, an indication of a purpose of the contact, etc.

A communication table 304 has entries each one of which comprises a communication record 204. Each communication record 204 has a communication ID 340 that uniquely identifies the communication, and a plurality of data fields 342 that contain any desired information about the communication, e.g., type of matter to which it pertains, the result of the communication (of its constituent contacts), the value and cost of the communication to the business, etc.

A communication-contact relationship table 300 has entries each one of which comprises a link 200. Each link 200 has a communication identifier 340 and a contact identifier 320, thereby linking the identified contact and its record with the identified communication and its record, and vice versa.

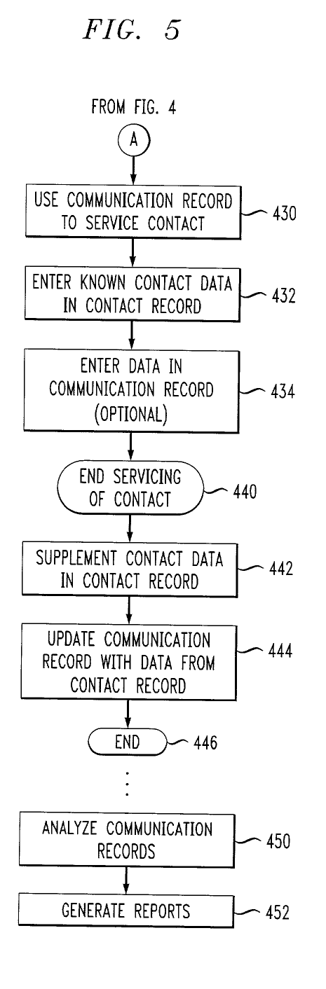

Generation and use of records 202 and 204 and links 200 is illustratively shown in FIGS. 4 and 5. Upon a new customer contact being either received or initiated by contact center 100, at step 400, ACD system 100 or CRM system 116, respectively, generates a new contact record 202 with a unique contact ID 320 for this contact, at step 402, and populates data fields 322 of the new contact record 202 with whatever information it presently has about that contact, at step 404. For example, if the contact is a received call, ACD system 110 may know the ANI and the DNIS of the call, and its IVR system may have collected a customer identifier, an account number, a matter description, and/or a communication identifier from the caller, and this information is entered by ACD system 110 into the contact record. CRM system 116 then tries to correlate the information in the contact record 202 with the information in existing communication records 204 in order to determine if the contact relates to any existing communication, at step 406.

If a relationship is found to exist at step 406, CRM system 116 creates a new link 200 in table 300 linking the contact record 202 to the communication record 204 of the related communication, at step 408. ACD system 110 may then use data 342 of the linked communication record 204 to select a resource 112-114 to service the contact, at step 410, and assigns the contact to the selected resource for servicing, at step 412.

Returning to step 406, if no relationship is found there between the contact and an existing communication, a resource 112-114 is selected to service the contact and the contact is assigned thereto, in a conventional manner, at step 420. The selected resource enters any data that it obtains regarding the contact into data field 322 of the contact record 202, at step 422, and CRM system 116 again tries to correlate the information in the contact record 202 with the information in existing communication records 204 in order to determine if the contact relates to any existing communication, at step 424. Steps 422 and 424 may be repeated as often as necessary.

If no relationship is found to exist at step 424, CRM system 116 creates in table 300 a new communication record 204 with a unique communication ID 340 for this communication, at step 426. Following step 426, or if a relationship between the contact and an existing communication is found to exist at step 424, CRM system 116 creates a new link 200 in table 300 linking the contact record 202 to the communication record 204 of the new or related communication, at step 428. Following step 412 or 428, the serving resource may use data 342 of the communication record 204 to service the contact—for example, the resource need not ask the customer questions that are answered by the data 342 of the communication record 204—at step 430 of FIG. 5. The selected resource also enters any new data regarding the contact into data fields 322 of the contact record 202, at step 432. Optionally, the serving resource may also enter data regarding the communication into data fields 342 of the corresponding communication's record, at step 434.

When servicing of the contact ends, at step 440, data 322 of the contact record 202 is supplemented with any final data regarding the contact—e.g., disposition of the contact and the time when servicing of the contact ended, at step 442. CRM system 116 then uses data 322 of the contact record 202 to update data 342 of the linked communication record 204, at step 444. Creation of records 202 and 204 and links 200 then ends, at step 446.

Subsequently, CRM system 116 analyzes contents of communication records 204, at step 450, to generate reports to managers of contact center 100 and the business that that contact center represents, at step 452. These reports may be used, inter alia, to gain a better understanding of the customers of the business and their needs, to gain a better understanding of the operation of contact center 100, to improve the operation of contact center 106, etc.

Of course, various changes and modifications to the illustrative embodiment described above will be apparent to those skilled in the art These changes and modifications can be made without departing from the spirit and the scope of the invention and without diminishing its attendant advantages. It is therefore intended that such changes and modifications be covered by the following claims except insofar as limited by the prior art.

What is claimed is:

1. A method comprising:
in response to each instance of communication between a contact center and a customer of the contact center regarding at least one matter, creating for that instance in a storage medium a contact record including information about the at least one matter;
further in response to each said instance, determining whether an individual said matter is a matter of an existing communication comprising at least one prior communication instance between the customer and the contact center;
in response to determining that the individual matter of the instance is not a matter of any said existing communication, creating for that communication in the storage medium a communication record corresponding to the individual matter of the customer and including information about said individual matter, and linking the contact record with the communication record; and
in response to determining that the individual matter of the instance is a matter of a said existing communication, linking the contact record with the communication record.

2. The method of claim 1 further comprising:
using the information in the communication record which is linked to the contact record for the instance to service that instance; and
including information derived from servicing the instance in the contact record for that instance.

3. The method of claim 2 further comprising:
including information derived from the contact record for that instance in the communication record which is linked to the contact record for that instance.

4. The method of claim 1 wherein:
creating a contact record comprises
creating a data entry having a unique contact identifier;
creating a communication record comprises
creating a data entry having a unique communication identifier; and
linking comprises
creating a data entry containing the contact identifier and the communication identifier.

5. An apparatus that performs the method of one of claims 1-4.

6. A computer-readable medium containing instructions which when executed in a computer, cause the computer to perform the method of one of claims 1-4.

7. An apparatus comprising:
a storage medium;
means responsive to each instance of communication between a contact center and a customer of the contact center regarding at least one matter, for creating for that instance in the storage medium a contact record including information about the at least one matter;
means responsive to each said instance, for determining whether an individual said matter is a matter of an existing communication comprising at least one prior communication instance between the customer and the contact center;
means responsive to a determination that the individual matter of the instance is not a matter of any said existing communication, for creating for that communication in the storage medium a communication record corresponding to the individual matter of the customer and including information about said individual matter and for linking the contact record with the communication record, and responsive to a determination that the individual matter of the instance is not a matter of a said existing communication, for linking the contact record with the communication record.

8. The apparatus of claim 7 further comprising:
means for using the information in the communication record which is linked to the contact record for the instance to service that instance; and
means for including information derived from servicing the instance in the contact record for that instance.

9. The apparatus of claim 8 further comprising:
means for including information derived from the contact record for that instance in the communication record which is linked to the contact record for that instance.

10. The apparatus of claim 7 wherein:
the contact record comprises a data entry having a unique contact identifier;
the communication record comprises a data entry having a unique communication identifier; and
the means for creating and linking comprises
means for creating a data entry containing the contact identifier and the communication identifier to link the communication record with the contact record.

11. An apparatus comprising:
a storage medium for storing
a plurality of contact records, each representing a different instance of communication between a contact center and a customer of the contact center regarding at least one matter and including information about the at least one matter, and
a plurality of communication records, each corresponding to a different one of a plurality of matters of the customer, including said at least one matter, each communication record being linked to each contact record of the plurality of contact records that corresponds to same said matter as the communication record, and including information about said matter; and
means connected to the data storage and responsive to instances of communication between the customer and the call center for generating and linking corresponding said contact records and communication records.

12. The apparatus of claim 11 wherein:
the generating means are further for populating each contact record with information about the corresponding contact and populating each communication record with information about the corresponding matter.
